(19) United States
(12) Patent Application Publication
(10) Pub. No.: US 2011/0121209 A1
(43) Pub. Date: May 26, 2011

(54) Terahertz radiation source and method for generating terahertz radiation

(76) Inventors: Michael Thiel, Leonberg (DE); Ulrich Kallmann, Tuebingen (DE); Stefan Kundermann, Lausanne (CH)

(21) Appl. No.: 13/055,659

(22) PCT Filed: Jun. 9, 2009
(86) PCT No.: PCT/EP2009/057072

§ 371 Date: Jan. 24, 2011

(30) Foreign Application Priority Data
Aug. 7, 2008 (DE) 102008041107.8

(51) Int. Cl. G02F 1/35

(52) U.S. Cl. 250/493.1

(57) ABSTRACT

A terahertz radiation source is described which includes a pulsed femtosecond fiber laser, a pulse shaper, an optical amplifier and a nonlinear crystal, wherein the laser, pulse shaper, optical amplifier and nonlinear crystal are configured and/or situated in such a way that a laser pulse I, II, III, IV produced by the laser first passes through the pulse shaper, then the optical amplifier, and then the nonlinear crystal. Also described is a related imaging and/or spectroscopy system, a method for generating terahertz radiation, a method for detecting and/or examining life forms, objects, and materials using a system of this type, and a use of a source and a system of this type.

### FIELD OF THE INVENTION

The present invention relates to a terahertz radiation source, an imaging and/or spectroscopy system, a method for generating terahertz radiation, a method for detecting and/or examining life forms, objects, and materials using a system of this type and use of a source of this type and a system of this type.

### BACKGROUND INFORMATION

The electromagnetic spectrum in the range of the terahertz frequency band may provide information about the complex chemical composition of substances as well as the dielectric properties of objects. Detection of explosive materials without direct contact is of particular interest in this context. A corresponding sample is bombarded by a terahertz radiation source, and the reflected, transmitted, and/or scattered radiation is analyzed.

A system for spectral identification of explosive materials may be based on a terahertz radiation source, which generates terahertz radiation adjustable within a wide frequency range, and on a broadband terahertz radiation detector. In a system of this type, the spectral resolution is achieved by tuning the terahertz frequency and simultaneously recording the corresponding received intensity. In contrast with time-domain spectroscopy, which requires particularly broadband terahertz radiation sources, a tunable narrow-band terahertz radiation source is required for a system of this type.

It is known that nonlinear optical effects, for example, differential frequency generation, may be used for such a tunable narrow-band terahertz radiation source.

However, at least two optical pulses of different frequencies are required to be able to utilize differential frequency generation.

Traditionally such optical pulses of different frequencies are generated by an optical parametric oscillator and are converted to terahertz radiation by generating differential frequency in a nonlinear crystal, where the terahertz frequency corresponds to the differential frequency of the pulses. However, it is problematical here that optical parametric oscillators are extremely susceptible to impacts and temperature fluctuations.

### SUMMARY OF THE INVENTION

The terahertz radiation source according to the present invention, including
a pulsed femtosecond fiber laser,
a pulse shaper,
an optical amplifier, in particular a fiber amplifier, and
a nonlinear crystal,
   whose lasers, pulse shapers, optical amplifiers, and nonlinear crystal are designed and/or situated in such a way that a laser-generated laser pulse passes first through the pulse shaper, then the optical amplifier, and next the nonlinear crystal, has the advantage that all the components have a lower susceptibility to interference, in particular with respect to impacts and fluctuations in temperature. In addition, all the components may be components operated in the telecom band at 1550 nm, which may be manufactured at low production unit costs in the long run, thus permitting use in mass-produced devices.

Additional advantages and advantageous embodiments of the subject according to the present invention are illustrated in the drawings and explained in the following description. It should be noted here that the figures have only a descriptive character and are not intended to restrict the present invention in any way.

### BRIEF DESCRIPTION OF THE DRAWINGS

FIG. 1 shows a schematic block diagram of a terahertz radiation source according to the present invention.

FIG. 2 shows a graph to illustrate the frequency domains of a laser pulse before and after passing through a pulse shaper having Gaussian filter properties.

### DETAILED DESCRIPTION

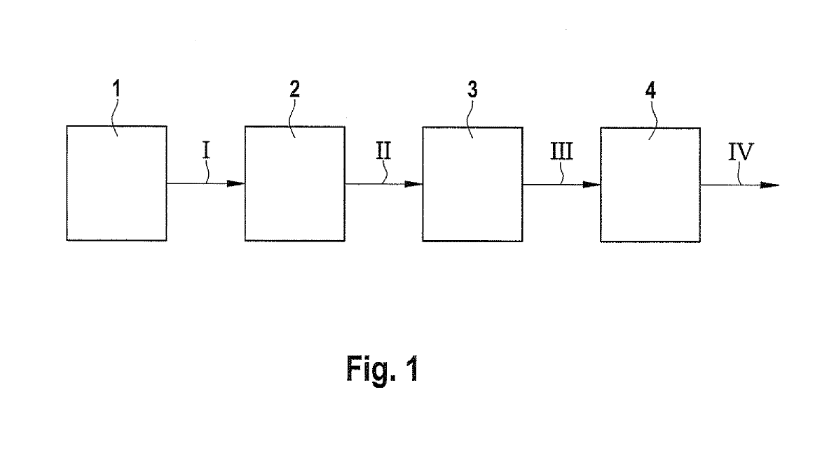

FIG. 1 shows that a terahertz radiation source according to the present invention includes a pulsed femtosecond fiber laser 1, a pulse shaper 2, an optical amplifier 3, and a nonlinear crystal 4. According to the present invention, these are designed and/or situated as shown in FIG. 1 in such a way that a laser pulse I, II, III, IV generated by laser 1 passes through pulse shaper 2, then optical amplifier 3, and next nonlinear crystal 4.

Within the scope of the present invention, a fiber laser is understood to be a solid-state laser, whose laser-active medium is formed by an erbium-, ytterbium-, and/or neodymium-doped glass fiber, for example. Such a laser advantageously generates light having a high beam quality and has a robust design, high efficiency of the conversion process, and good cooling due to the large surface area of the fiber.

Within the scope of the present invention, a femtosecond fiber laser is understood to be a fiber laser which generates laser pulses, the duration of which is in the femtosecond range. The femtosecond range is understood to be a range from ≧50 fs to ≦500 fs.

Within the scope of the present invention, a pulse shaper is understood to be a device which shapes a laser pulse I into a laser pulse II whose spectrum has at least two peaks at different frequencies and/or which shapes a laser pulse I into at least two laser pulses II of different frequencies. For example, a pulse shaper is understood to be a device which shapes a laser pulse I into a laser pulse II whose spectrum has two peaks at different frequencies or which shapes a laser pulse I into two laser pulses II of different frequencies. Such devices are referred to as “pulse shapers” among other things. The pulse shaper may, but need not necessarily, contain optical components and/or modules for pulse widening, for pulse compression, or for chirp compensation. The term “chirp” is understood within the scope of the present invention to refer to a time distortion of pulses due to the dispersion properties of the optical components (fibers, prisms, etc.).

Within the scope of the present invention, an optical amplifier is understood to be a device which amplifies an incoming optical signal of a wavelength or a wavelength range and forwards it as an optical signal of the same wavelength and/or the same wavelength range. The optical amplifier may, but need not, include optical components and/or modules for pulse widening, pulse compression, or chirp compensation.

Narrow-band terahertz radiation adjustable within a wide frequency range may be generated by a terahertz radiation source according to the present invention. Within the scope of the present invention, terahertz radiation is understood to be electromagnetic radiation in a range from ≧15 μm to ≦1000 μm. Narrow-band may be understood to refer to a terahertz radiation having a width of ≧1 gigahertz to ≦1 terahertz, in particular from ≧20 gigahertz to ≦200 gigahertz. A broad frequency range may be understood to be ≧0.3 terahertz to ≦20 terahertz, for example, ≧0.3 terahertz or ≧0.5 terahertz or terahertz to ≦3 terahertz or to ≦5 terahertz or to terahertz.

Within the scope of a specific embodiment of the present invention, optical amplifier 3 is an erbium-doped fiber amplifier, for example. Within the scope of the present invention, a fiber amplifier is understood to be an optically pumped power amplifier for light signals guided in glass fiber waveguides (optical fibers).

Within the scope of another specific embodiment of the present invention, fiber laser 1 generates laser pulses having a period of ≧50 fs to ≦500 fs, for example, 100 fs.

Within the scope of another specific embodiment of the present invention, the central wavelength of fiber laser 1 is in a range from ≧1500 nm to ≦1600 nm, for example, ≧1530 nm to ≦1570 nm. For example, the central wavelength of the laser may be 1550 nm. Furthermore, fiber laser 1 may be a double-clad fiber laser.

Within the scope of the present invention, pulse shaper 2 may split laser pulse I both symmetrically and asymmetrically into at least two laser pulses II of different frequencies. If laser pulse I generated by fiber laser 1 is symmetrical, for example, a symmetrically splitting pulse shaper 2 may be used.

If laser pulse I generated by fiber laser 1 is asymmetrical, then an asymmetrically splitting pulse shaper 2 may advantageously be used, so that through its asymmetry, it cancels the asymmetry of laser pulse I generated by fiber laser 1.

Within the scope of another specific embodiment of the present invention, pulse shaper 2 is a grating-based pulse shaper, a prism-based pulse shaper, or a Mach-Zehnder interferometer having integrated Fabry-Pérot filters.

The Mach-Zehnder interferometer may include a first beam splitter, for example, a first Y-fiber coupler, for splitting laser pulse I into a first and a second laser pulse, a Fabry-Pérot filter for filtering out a frequency from the first laser pulse and a second Fabry-Pérot filter for filtering out another frequency from the second laser pulse, and a second beam splitter, for example, a second Y-fiber coupler for superimposing the first and second laser pulses.

Within the scope of the present invention, a beam splitter is understood to be a device which splits one incident beam of light into two beams of light or superimposes two incident beams of light. Within the scope of the present invention, a Y-fiber coupler is understood to be a component which splits a light signal in one glass fiber into two glass fibers or which superimposes the signals from two glass fibers in a single glass fiber.

In such a Mach-Zehnder interferometer, original laser pulse I is split by the first beam splitter into two interferometer branches of the Mach-Zehnder interferometer. Each of these two branches has a Fabry-Pérot filter, each filtering one frequency out of the laser spectrum. The two lines, for example, Lorentzian lines, are then superimposed again in the second beam splitter and transmitted to optical amplifier 3.

The Fabry-Pérot filters may be traditional Fabry-Pérot filters, for example, based on solid dielectric structures. In this case, the frequency difference between the two split laser pulses may be adjusted by tilting the Fabry-Pérot filters, for example.

Within the scope of a particularly specific embodiment of the present invention, the Fabry-Pérot filters are microelectromechanical Fabry-Pérot filters or MEMS resonators (MEMS: microelectromechanical system). In this case, the frequency difference between the two split laser pulses may be adjusted, for example, by a change in the distance between the mirror elements of the Fabry-Pérot filter, this change being controlled electrically in particular.

The microelectromechanical Fabry-Pérot filter may be integrated into a glass fiber element. For example, within the scope of one specific embodiment, the Mach-Zehnder interferometer includes a first Y-fiber coupler for splitting laser pulse I into a first and a second laser pulse, a first microelectromechanical Fabry-Pérot filter integrated into a glass fiber element for filtering a frequency out of the first laser pulse and a second microelectromechanical Fabry-Pérot filter integrated into a glass fiber element for filtering another frequency out of the second laser pulse, and a second Y-fiber coupler for superimposing the first and second laser pulses.

Within the scope of the present invention, a DAST crystal (DAST: 4′-dimethylamino-N-methyl-4-stilbazolium tosylate), a ZnTe crystal, a CdTe crystal, or a GaAs crystal, for example, may be used as the nonlinear crystal.

Another subject matter of the present invention is a method for generating terahertz radiation using a terahertz radiation source according to the present invention, which includes the method steps:
1. generating a laser pulse I, in particular using a broad frequency distribution, by laser 1,
2. reshaping laser pulse I
   into a laser pulse II whose spectrum has at least two peaks at different frequencies and/or
   into at least two laser pulses II of different frequencies by pulse shaper 2;
3. amplifying
   laser pulse II, whose spectrum has at least two peaks at different frequencies, to an amplified laser pulse III and/or
   laser pulses II of different frequencies to amplified laser pulses III using optical amplifier 3, and
4. generating terahertz radiation IV
   by differential frequency generation of differential frequency f_{THz} between the peaks at different frequencies of amplified laser pulse III and/or
   by differential frequency generation of differential frequency f_{THz} between the different frequencies of amplified laser pulses III using nonlinear crystal 4.

A laser pulse I having a “broad frequency distribution” may be understood to be a laser pulse having a′frequency distribution width of ≧5 THz to ≦10 THz, for example.

Laser pulse, I may be shaped using a grating-based or prism-based pulse shaper 2, for example, into a laser pulse II, whose spectrum has at least two peaks at different frequencies. Laser pulse I may be shaped into at least two laser pulses II of different frequencies by a Mach-Zehnder interferometer having integrated Fabry-Pérot filters as pulse shaper 2.

The frequency of terahertz radiation IV may be set by tuning pulse shaper 2, in particular by tuning differential frequency f_{THz}.

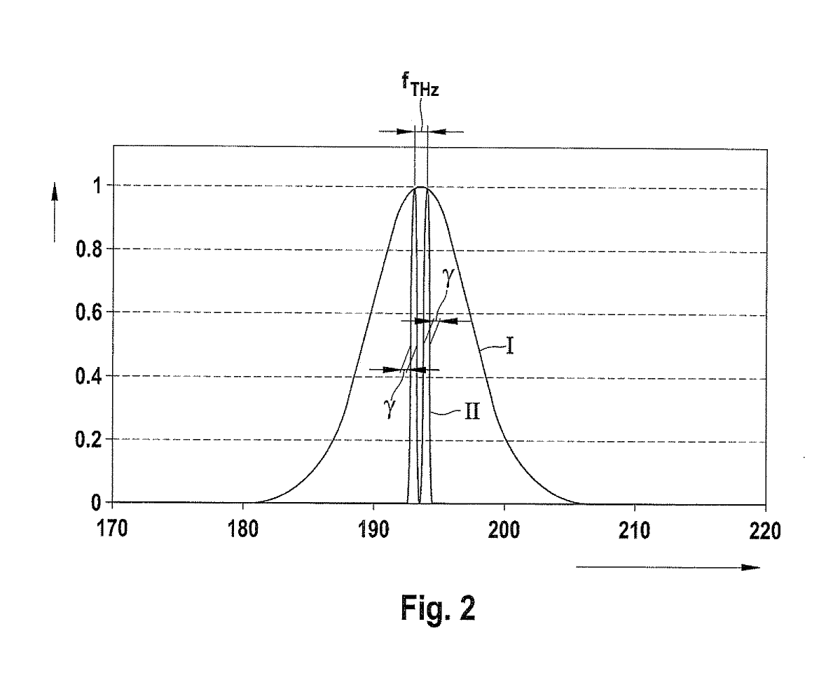

Converted laser pulses II as well as amplified laser pulses III, as shown in FIG. 2, may have a symmetrical pulse shape. Distortions of the pulse shape occurring due to any nonlinearities of optical amplifier 3 may be compensated by an appropriate adjustment of pulse shape II fed into optical amplifier 3 by pulse shaper 2. For example, spectral distribution III, in particular the pulse shape, may be measured downstream from optical amplifier 3, pulse shape II required to achieve a symmetrical pulse shape III may be calculated by a logic arrangement (not shown), for example, a microprocessor, and pulse shaper 2 may be set by an output of the logic arrangement in such a way that it generates pulse shape II required to achieve a symmetrical pulse shape III, in particular an asymmetrical pulse shape.

The method according to the present invention is therefore advantageously suitable for generating a narrow-band terahertz radiation, which is adjustable within a broad frequency range.

FIG. 1 shows that within the scope of the method according to the present invention, laser pulses I may be generated, for example, to have a period in the range of 100 fs by femtosecond fiber laser 1. These laser pulses I are fed into a pulse shaper 2. Pulse shaper 2 shapes a laser pulse I into a laser pulse II whose spectrum has at least two peaks at different frequencies and/or shapes it into at least two laser pulses II of different frequencies.

Such a reshaping of a laser pulse I is illustrated in FIG. 2. FIG. 2 shows the reshaping of a laser pulse I using a Gaussian pulse shaper in the frequency domains.

FIG. 2 illustrates that two spectral lines having width γ are selected by pulse shaper 2 from laser pulse I generated by the fiber laser, their central frequencies differing from one another by frequency f_{THZ}. FIG. 2 also shows that the two spectral lines are symmetrical about central original laser wavelength I within the scope of the specific embodiment shown here. However, within the scope of other specific embodiments according to the present invention, it may also be an asymmetrical distribution, in particular an asymmetrical configuration. Differential frequency f_{THZ} which corresponds to the frequency of terahertz radiation IV generated subsequently may be achieved by tuning pulse shaper 2. After passing through pulse shaper 2, pulse shapes II which are shaped by pulse shaper 2 are amplified in optical amplifier 3, in particular a fiber amplifier, so that the electrical field in the nonlinear material of nonlinear crystal 4 is sufficient to induce a nonlinear effect by nonlinear crystal 4. Amplified laser pulses III finally reach nonlinear crystal 4, through which terahertz radiation IV having terahertz frequency f_{THZ} is generated by a nonlinear effect. The nonlinear effect may be differential frequency generation in particular.

Line width γ of terahertz radiation IV corresponds essentially to width γ of two frequencies II filtered in the pulse shaper. Differential frequency f_{THz} and thus the frequency of terahertz radiation IV may be varied in a very wide range by varying the frequency of one or both spectral lines. The minimal frequency of the terahertz radiation source according to the present invention is given approximately by width γ. The order of magnitude of the maximum frequency of the terahertz radiation source according to the present invention is obtained from the width of original laser pulse I in the frequency domain.

Furthermore, the exemplary embodiments and/or exemplary methods of the present invention relates to an imaging and/or spectroscopy system, including a terahertz radiation source according to the present invention and a terahertz radiation sensor, which functions as a detector. The terahertz radiation source according to the present invention and the terahertz radiation sensor may be positioned with respect to the object examined so that the terahertz radiation sensor detects the radiation remaining after passing through the object and also the terahertz radiation sensor detects the radiation scattered and/or reflected by the object. Consequently, the terahertz radiation source, the terahertz radiation sensor, and the object may be positioned along an axis, the object being positioned between the terahertz radiation source and the terahertz radiation sensor, as well as not being positioned along an axis relative to one another. The system according to the present invention advantageously allows real-time spectroscopy in the terahertz radiation range and imaging detection in the terahertz radiation range.

Within the scope of a specific embodiment of the imaging and/or spectroscopy system according to the present invention, it is a multispectral imaging and/or spectroscopy system, which includes, in addition to the terahertz radiation sensor, additional radiation sensors, in particular sensors for radiation of the visible, near infrared, and/or infrared range.

In addition, the exemplary embodiments and/or exemplary methods of the present invention relates to a method for detecting and/or examining life forms, in particular humans and animals, objects and materials using a system according to the present invention. This method may be based on frequency-range spectroscopy in particular. The terahertz radiation source according to the present invention may emit a narrow terahertz radiation band in the method according to the present invention having a width of ≧1 gigahertz to ≦1 terahertz, for example, in particular from ≧20 gigahertz to ≦200 gigahertz, which is varied within a broad frequency range, for example, in a range from ≧0.3 terahertz to ≦20 terahertz, for example, from ≧0.3 terahertz or ≧0.5 terahertz or ≧1 terahertz to ≦3 terahertz or ≦5 terahertz or ≦10 terahertz, the transmitted, reflected and/or scattered radiation being detected, in particular being measured, by the terahertz radiation sensor, in particular a broadband sensor. A broadband terahertz radiation sensor is understood to be, for example, a terahertz radiation sensor whose detection interval is ≧0.3 terahertz to ≦20 terahertz, in particular ≧0.3 terahertz or ≧0.5 terahertz or ≧1 terahertz or ≧1.5 terahertz to ≦2.5 terahertz or ≦3 terahertz or ≦5 terahertz or ≦10 terahertz. Within the scope of the method according to the present invention, the measurement result of the terahertz radiation sensor may be output by an output device, for example, a display, a screen, or a printer.

In addition, the exemplary embodiments and/or exemplary methods of the present invention relates to the use of a terahertz radiation source according to the present invention, a system and/or a method according to the present invention in the monitoring/safety engineering, transportation, production, packaging, life science, and/or medical fields. The present invention relates in particular to the use of a terahertz radiation source according to the present invention, a system and/or a method according to the present invention for detecting and/or examining life forms, in particular humans and animals, objects and materials, in particular explosives, for example, in security checks at borders, in transit buildings such as airports and train stations, in transportation facilities such as railroads, buses, airplanes and/or boats, and/or at large-scale events, for burglary protection of buildings, rooms, and a manner of travel, for medical purposes, and/or for nondestructive testing of workpieces, in particular workpieces made of plastic. For example, the terahertz radiation source according to the present invention, the system and/or the method according to the present invention may be used in a multispectral camera for access monitoring of sensitive infrastructures and borders, for nondestructive materials testing, for monitoring of packaging machines, or for determining the chemical composition of biological tissue.

1-14. (canceled)

15. A terahertz radiation source for generating a narrow-band terahertz radiation, adjustable within a broad frequency range, comprising:
a pulsed femtosecond fiber laser;
a pulse shaper;
an optical amplifier; and
a nonlinear crystal;
wherein the laser, the pulse shaper, the optical amplifier, and the nonlinear crystal are configured so that a laser pulse generated by the laser passes first through the pulse shaper, then the optical amplifier, and next the nonlinear crystal.

16. The terahertz radiation source of claim 15, wherein the optical amplifier is a fiber amplifier.

17. The terahertz radiation source of claim 15, wherein the laser generates laser pulses having a period of ≧50 fs to ≦500 fs.

18. The terahertz radiation source of claim 15, wherein the central wavelength of the laser is in a range from ≧1500 nm to ≦1600 nm.

19. The terahertz radiation source of claim 15, wherein the pulse shaper is one of a grating-based pulse shaper, a prism-based pulse shaper, and a Mach-Zehnder interferometer having integrated Fabry-Pérot filters.

20. The terahertz radiation source of claim 19, herein the pulse shaper is a Mach-Zehnder interferometer, which includes (i) a first beam splitter for splitting the laser pulse into a first and a second laser pulse, (ii) a first Fabry-Pérot filter for filtering out a frequency from the first laser pulse and a second Fabry-Pérot filter for filtering out another frequency from the second laser pulse, and (iii) a second beam splitter for superimposing the first laser pulse and the second laser pulse.

21. The terahertz radiation source of claim 20, wherein at least one of the first beam splitter and the second beam splitter includes a Y-fiber coupler.

22. The terahertz radiation source of claim 20, wherein the Fabry-Pérot filters are microelectromechanical Fabry-Pérot fitters.

23. The terahertz radiation source of claim 15, wherein the terahertz radiation source generates terahertz radiation having a width of ≧1 gigahertz to ≦1 terahertz, which is adjustable within a frequency range from ≧0.3 terahertz to ≦20 terahertz.

24. A method for generating a narrow-band terahertz radiation adjustable within a broad frequency range, the method comprising:
generating a laser pulse by a laser, which is a pulsed femtosecond fiber laser;
reshaping the laser pulse into at least one of a laser pulse whose spectrum has at least two peaks at different frequencies, and at least two laser pulses of different frequencies, using a pulse shaper;
at least one of amplifying the laser pulse whose spectrum has at least two peaks at different frequencies to form an amplified laser pulse, and the laser pulses of different frequencies to amplified laser pulses, using and optical amplifier; and
generating terahertz radiation by at least one of a differential frequency generation of a differential frequency between the peaks at different frequencies of the amplified laser pulse, and by differential frequency generation of the differential frequency between the different frequencies of the amplified laser pulses, using a nonlinear crystal;
wherein the laser, the pulse shaper, the optical amplifier, and the nonlinear crystal are configured so that a laser pulse generated by the laser passes first through the pulse shaper, then the optical amplifier, and next the nonlinear crystal.

25. The method of claim 24, wherein the frequency of the terahertz radiation is adjusted by tuning the pulse shaper, by tuning the differential frequency.

26. An imaging/spectroscopy system, comprising:
a terahertz radiation source for generating a narrow-band terahertz radiation, adjustable within a broad frequency range, including:
a pulsed femtosecond fiber laser,
a pulse shaper,
an optical amplifier, and
a nonlinear crystal,
wherein the laser, the pulse shaper, the optical amplifier, and the nonlinear crystal are configured so that a laser pulse generated by the laser passes first through the pulse shaper, then the optical amplifier, and next the nonlinear crystal; and
a terahertz radiation sensor.

27. A method for at least one of detecting and examining life forms, including humans and animals, objects and materials, using a imaging/spectroscopy system, the method comprising:
emitting narrow-band terahertz radiation, which is varied within a broad frequency range by using a terahertz radiation source of the imaging/spectroscopy system, wherein the terahertz radiation source is for generating a narrow-band terahertz radiation, adjustable within the broad frequency range, and includes a pulsed femtosecond fiber laser, a pulse shaper, an optical amplifier, and a nonlinear crystal, wherein the laser, the pulse shaper, the optical amplifier, and the nonlinear crystal are configured so that a laser pulse generated by the laser passes first through the pulse shaper, then the optical amplifier, and next the nonlinear crystal; and
detecting at least one of the transmitted, reflected and scattered radiation with a terahertz radiation sensor of the imaging/spectroscopy system.

28. The terahertz radiation source of claim 15, wherein the terahertz radiation source is used for at least one of monitoring, safety engineering, transportation, production, packaging, life science, and medical fields.

29. The terahertz radiation source of claim 15, wherein the terahertz radiation source is used for at least one of detecting and examining life forms, objects and materials.
